(19) United States
(12) Patent Application Publication
(10) Pub. No.: US 2023/0273541 A1
(43) Pub. Date: Aug. 31, 2023

(54) TONER AND METHOD FOR PRODUCING TONER

(71) Applicant: CANON KABUSHIKI KAISHA, Tokyo (JP)

(72) Inventors: MASATAKE TANAKA, Kanagawa (JP); TAIJI KATSURA, Shizuoka (JP); SHINTARO KAWAGUCHI, Kanagawa (JP); DAI NOZAKI, Shizuoka (JP)

(21) Appl. No.: 18/173,408

(22) Filed: Feb. 23, 2023

(30) Foreign Application Priority Data
Feb. 28, 2022 (JP) 2022-028818

(51) Int. Cl. G03G 9/097; G03G 9/08; G03G 9/087

(52) U.S. Cl. CPC G03G 9/09725; G03G 9/0827; G03G 9/08711; G03G 9/0821; G03G 9/09733; G03G 9/09708

(57) ABSTRACT

The present disclosure provides a toner excellent in low-temperature fixability and excellent in durability under harsh environments of high-temperature and high-humidity, and a method for producing the toner. The toner can contain: a toner particle containing a binder resin, wax, and an inorganic oxide particle; and an external additive, wherein the inorganic oxide particle contains, as a main component, an oxide of at least one element selected from the group consisting of Si, Mg, Al, Ti, and Sr; when a thin piece obtained by cutting the toner with a microtome is observed with a transmission electron microscope (TEM), the major axis A of the inorganic oxide particle is 0.10 to 3.00 μm; and in a wettability test of the toner with respect to a methanol/water mixed solvent, a methanol concentration at a transmittance of light having a wavelength of 780 nm of 50% is 5.0 to 30.0% by volume.

### BACKGROUND OF THE INVENTION

### Field of the Invention

The present disclosure relates to a toner used in an image forming method such as an electrophotographic method, an electrostatic recording method, a toner jet method, and a method for producing the toner.

### Description of the Related Art

In recent years, printers and copiers are required to have higher speeds and lower power consumption, and the development of toners with excellent low-temperature fixability and heat-resistant storage stability has been required. In response to this demand, Japanese Patent Application Laid-Open No. 2007-140368 proposes a method for achieving both low-temperature fixability and heat-resistant storage stability by using a low-melting point wax and silica.

Although the above proposal improves low-temperature fixability and heat-resistant storage stability, there remains a problem with durability under harsh environments of high-temperature and high-humidity. Today, as multifunction machines and printers are becoming more popular and used in various regions and environments, toners excellent in durability under harsh environments of high-temperature and high-humidity have been required.

Therefore, the problem to be solved by the present disclosure is to provide a toner excellent in low-temperature fixability and excellent in durability under harsh environments of high-temperature and high-humidity, and a method for producing the toner.

### SUMMARY OF THE INVENTION

The present disclosure relates to a toner containing: a toner particle containing a binder resin, wax, and an inorganic oxide particle; and an external additive, wherein the inorganic oxide particle contains, as a main component, an oxide of at least one element selected from the group consisting of Si, Mg, Al, Ti, and Sr; when a thin piece obtained by cutting the toner with a microtome is observed with a transmission electron microscope (TEM), the major axis A of the inorganic oxide particle is 0.10 to 3.00 μm; and in a wettability test of the toner with respect to a methanol/water mixed solvent, a methanol concentration at a transmittance of light having a wavelength of 780 nm of 50% is 5.0 to 30.0% by volume.

The present disclosure further relates to a method for producing a toner, the toner comprising a toner particle containing a binder resin, wax, and an inorganic oxide particle, and an external additive, the method including: melt-kneading, wherein the inorganic oxide particle contains, as a main component, an oxide of at least one element selected from the group consisting of Si, Mg, Al, Ti, and Sr; when a thin piece obtained by cutting the toner with a microtome is observed with a transmission electron microscope (TEM), the major axis A of the inorganic oxide particle is 0.10 to 3.00 μm; and in a wettability test of the toner with respect to a methanol/water mixed solvent, a methanol concentration at a transmittance of light having a wavelength of 780 nm of 50% is 5.0 to 30.0% by volume.

Further features of the present invention will become apparent from the following description of exemplary embodiments with reference to the attached drawings.

### BRIEF DESCRIPTION OF THE DRAWINGS

FIG. 1 is a diagram for describing a sharp portion.

FIG. 2 is a graph illustrating an example of a methanol drop transmittance curve in a wettability test.

### DESCRIPTION OF THE EMBODIMENTS

Embodiments of the present invention will now be described in detail in accordance with the accompanying drawings.

In the present disclosure, the notations “XX or more and YY or less” and “XX to YY” representing a numerical range denote, unless otherwise stated, a numerical value range that includes the lower limit and the upper limit thereof, as endpoints. In a case where numerical value ranges are described in stages; the upper limits and the lower limits of the respective numerical value ranges can be combined arbitrarily.

In the present disclosure, “(meth)acryl” means “acryl” and/or “methacryl”.

A toner of the present disclosure will be described in more detail below.

[Features of the Present Invention]

As a result of diligent study to solve the above problems in the related art, the present inventors have found that the above problems can be solved by incorporating an inorganic oxide particle having specific components and particle size in the toner particle and controlling, in a wettability test of the toner with respect to a methanol/water mixed solvent, the methanol concentration at a transmittance of light having a wavelength of 780 nm of 50% within a specific range.

That is, the present invention provides a toner containing: a toner particle containing a binder resin, wax, and an inorganic oxide particle; and an external additive, wherein the inorganic oxide particle contains, as a main component, an oxide of at least one element selected from the group consisting of Si, Mg, Al, Ti, and Sr, when a thin piece obtained by cutting the toner with a microtome is observed with a transmission electron microscope (TEM), the major axis A of the inorganic oxide particle is 0.10 to 3.00 μm, and in a wettability test of the toner with respect to a methanol/water mixed solvent, a methanol concentration at a transmittance of light having a wavelength of 780 nm of 50% is 5.0 to 30.0% by volume.

With respect to the reason why the effects of the present invention are obtained by satisfying the above conditions, the present inventors consider as follows.

Conventionally, as means for obtaining a toner having excellent low-temperature fixability and heat-resistant storage stability, methods have been studied in which a low-melting point wax and silica are contained so that the wax does not out-migrated in a high-temperature environment to some extent but the outmigration of the wax occurs during fixing. However, even in such a case, there has been a problem in that when continuous printing is performed under a high-temperature environment, the outmigration of the wax occurs when the toner is subjected to an external force, changing the surface properties of the toner and contaminating members when the out-migrated wax grows further, thereby causing image defects.

Meanwhile, under high-temperature and high-humidity, the external additive absorbs moisture and the triboelectricity is decreased, so that the suppression of fogging is deteriorated, and therefore, in order to improve the durability under high-temperature and high-humidity, an external additive that has been subjected to a hydrophobic treatment is generally used. However, there is a problem in that external additives that have been subjected to a hydrophobic treatment promote the outmigration of wax.

In the present invention, the inorganic oxide particle containing as a main component an oxide of at least one element selected from the group consisting of Si, Mg, Al, Ti, and Sr in a large range of the inorganic particles used for toners and having a major axis A of 0.10 to 3.00 μm are provided inside the toner particle, so that the wax passes through the interface between the binder resin and the inorganic oxide particle during fixing and the outmigration of the wax is facilitated. In addition, the surface of the toner is intentionally made hydrophilic so that in a wettability test of the toner with respect to a methanol/water mixed solvent, the methanol concentration at a transmittance of light having a wavelength of 780 nm of 50% is 5.0 to 30.0% by volume, and thus even when an external force is applied to the toner under high-temperature and high-humidity, the outmigration of the wax to the outermost surfaces of the toner is less likely to occur. Furthermore, the wax remaining between the toner particle and the external additive also suppresses a decrease in triboelectricity due to excessive moisture absorption of the toner surface, and as a result, suppresses fogging under high-temperature and high-humidity over a long period of time.

When the major axis A is less than 0.10 μm, the effect of improving the low-temperature fixability cannot be obtained. When the major axis A exceeds 3.00 μm, members such as a drum and a developing roller are scraped, resulting in poor durability. With respect to the surface properties of the toner, when the methanol concentration is less than 5.0% by volume, suppression of fogging under high-temperature and high-humidity is deteriorated, and when the methanol concentration exceeds 30.0% by volume, the outmigration of the wax in continuous printing under high-temperature and high-humidity cannot be suppressed, and image defects such as development streaks are caused. The methanol concentration can be controlled by adjusting the amount of hydroxyl groups remaining in the external additive and the amount of water of hydration.

From the viewpoint of durability, the wax is preferably at least one selected from the group consisting of a hydrocarbon wax and an ester wax. These waxes have good affinity with the inorganic oxide particle, and are considered to suppress excessive hygroscopicity of the hydrophilic surface of the toner.

It is preferable that when a thin piece obtained by cutting the toner with a microtome is observed with a transmission electron microscope (TEM), the shortest distance B between the inorganic oxide particle and surface of the toner particle and the shortest distance C between a domain of the wax and the surface of the toner particle satisfy B<C. When B<C is satisfied, the outmigration of the wax under high-temperature and high-humidity is further suppressed, and durability is improved. For example, in toner production by a pulverization method, the shortest distance B can be controlled by adjusting the major axis A of the inorganic oxide particle. The shortest distance B can also be controlled by selecting a wax that has good affinity with the binder resin (for example, ester wax for styrene-acrylic resin or polyester resin) or by adjusting kneading strength. When the degree of dispersion is increased, C tends to increase, and when the size of the wax domain is increased or the degree of dispersion is decreased, the wax tends to form a pulverization interface, and as a result, C tends to decrease.

Further, it is preferable that the relationship between the major axis A and the shortest distance B satisfies A>B. When A>B is satisfied, the outmigration of the wax under high-temperature and high-humidity is further suppressed, and durability is improved.

Furthermore, it is preferable that the major axis D of the external additive satisfies A>D with respect to the major axis A. When A>D is satisfied, the low-temperature fixability is improved. It is considered that the outmigration effect of the wax by the inorganic oxide particle is easily obtained during fixing.

It is preferable that when a thin piece obtained by cutting the toner with a microtome is observed with a transmission electron microscope (TEM), the inorganic oxide particles have a shape factor SF-1 of 140 or more. When SF-1 is 140 or more, the low-temperature fixability is improved. It is considered that the deformation causes anisotropy in the mobility of the inorganic oxide particles in the toner during fixing, and as a result, the outmigration effect of the wax by the inorganic oxide particle is easily obtained. The control method of SF-1 will be described later.

Also, it is preferable that when a thin piece obtained by cutting the toner with a microtome is observed with a transmission electron microscope (TEM), the inorganic oxide particle has a sharp portion. By having a sharp portion, the low-temperature fixability is improved. It is considered that, the presence of the sharp portion allows the inorganic oxide particle to be easily exposed to the surface of the toner during fixing, and as a result, the outmigration effect of the wax by the inorganic oxide particle is easily obtained. A method of controlling the presence or absence of the sharp portion will be described later.

The inorganic oxide particle is preferably silica. Silica improves the low-temperature fixability. It is considered that silica has good affinity with hydrocarbon wax and ester wax, and thus, the outmigration effect of the wax by the inorganic oxide particle is easily obtained.

The external additive preferably has a heating loss between 200° C. and 400° C. as measured by thermogravimetry (TGA) of 0.5 to 8.0%. In the present invention, this weight loss is derived from the hydroxyl group of the external additive, and is preferable for controlling the surface properties of the toner while imparting the fluidity of the toner, which is basically required in the electrophotographic process. When the content is less than 0.5%, it is difficult to obtain the effect of suppressing the outmigration of the wax, and when the content exceeds 8.0%, there is a tendency that the suppression of fogging is deteriorated, both of which are likely to be a trade-off with the fluidity of the toner. The heating loss can be controlled by adjusting the condensation degree by the reaction time during the production of the external additive, the temperature in the drying step, or the like.

Embodiments of the present invention will be described in detail below.

[Inorganic Oxide Particle]

Inorganic oxide particle of the present invention is not particularly limited in terms of production method, and those produced by known methods can be used. In particular, examples of the method for producing silica particles include a gas phase method in which metal silicon, a silicon halide, and a silicon compound such as a silane compound are reacted in a gas phase, and a wet method in which a silane compound such as alkoxysilane is hydrolyzed and subjected to a condensation reaction. Silica particles that can be used in the toner of the present invention can be produced by any method without restriction. Silica particles used in the present invention preferably have a number-average particle size D1 of 0.12 to 3.60 μm. Since these are relatively large, a gas-phase oxidation method is preferably used, in which powder raw materials are directly oxidized with a chemical flame composed of oxygen-hydrogen. The gas-phase oxidation method can instantaneously raise the temperature in the reaction vessel to the melting point of the inorganic fine powder or higher, and is a preferable production method for obtaining large silica particles.

As for the silica particles, for example, silica particles having a sharp portion can be obtained by producing silica particles of about 0.10 to 5.00 μm by the gas-phase oxidation method as described above and pulverizing the silica particles by a known method. As the pulverizer, for example, when an apparatus having a high pulverizing capability such as a pulverizer or a jet mill is used, it is easy to control the shape and the particle size. In addition, the particle size distribution can be appropriately adjusted using a known classifying apparatus.

In particular, in order to form sharp portions in the silica particles, it is preferable to include a pulverization step in the production of the silica particles. According to the study of the present inventors, it is difficult to form the sharp portion by a production method for a general fumed silica or sol-gel silica. In addition, the particle size distribution can be appropriately adjusted using a known classifying apparatus.

Similarly, the production method can be selected for the oxides of Mg, Al, Ti, and Sr without any restrictions. For example, an oxide is produced by refining or synthesizing a mineral as a raw material, and is adjusted to a size and shape suitable for the present invention by pulverizing or classifying as necessary.

[Binder Resin]

The toner contains a binder resin. The binder resin is not particularly limited, and known materials such as vinyl-based resins and polyester-based resins can be used.

Specifically, a styrene-based copolymer such as polystyrene, a styrene-propylene copolymer, a styrene-vinyltoluene copolymer, a styrene-methyl acrylate copolymer, a styrene-ethyl acrylate copolymer, a styrene-butyl acrylate copolymer, a styrene-octyl acrylate copolymer, a styrene-methyl methacrylate copolymer, a styrene-ethyl methacrylate copolymer, a styrene-butyl methacrylate copolymer, a styrene-octyl methacrylate copolymer, a styrene-butadiene copolymer, a styrene-isoprene copolymer, a styrene-maleic acid copolymer, or a styrene-maleic acid ester copolymer, polyacrylic acid ester, polymethacrylic acid ester, and polyvinyl acetate can be used, and these resins can be used alone or in combination of two or more thereof. The binder resin is preferably an amorphous resin. The binder resin is preferably a styrene-based copolymer or a polyester resin in terms of development characteristics, fixability, and the like. The polyester resin is preferably an amorphous polyester resin. The binder resin more preferably contains a styrene-acrylic resin. The styrene-acrylic resin improves durability, and the effects of the present invention are easily obtained until the latter half of durability in terms of extending the life.

Furthermore, the binder resin preferably has, in the molecular weight distribution of a tetrahydrofuran-soluble matter, at least two or more peaks or shoulders are present between a weight-average molecular weight Mw of 3,000 and a weight-average molecular weight Mw of 2,000,000. Having at least two peaks or shoulders between 3,000 and 2,000,000 improves the durability, and the effects of the present invention are easily obtained until the latter half of durability in terms of extending the life.

[Wax]

Examples of the ester wax used by the present invention include waxes in which the main component is a fatty acid ester, for example, carnauba wax and montanic acid ester wax; ester waxes provided by the partial or complete deacidification of the acid component from a fatty acid ester, for example, deacidified carnauba wax; hydroxyl group-bearing methyl ester compounds as obtained, for example, by the hydrogenation of plant oils and fats; saturated fatty acid monoesters, for example, stearyl stearate and behenyl behenate; diesters between a saturated aliphatic dicarboxylic acid and a saturated aliphatic alcohol, for example, dibehenyl sebacate, distearyl dodecanedioate, and distearyl octadecanedioate; and diesters between a saturated aliphatic diol and a saturated aliphatic monocarboxylic acid, for example, nonanediol dibehenate and dodecanediol di stearate.

Among these waxes, one embodiment utilizes a content of a difunctional ester wax (diester), which has two ester bonds in the molecular structure.

A difunctional ester wax is an ester compound between a dihydric alcohol and an aliphatic monocarboxylic acid or an ester compound between a dibasic carboxylic acid and an aliphatic monoalcohol.

Specific examples of the aliphatic monocarboxylic acid include myristic acid, palmitic acid, stearic acid, arachidic acid, behenic acid, lignoceric acid, cerotic acid, montanic acid, melissic acid, oleic acid, vaccenic acid, linoleic acid, and linolenic acid.

Specific examples of the aliphatic monoalcohol include myristyl alcohol, cetanol, stearyl alcohol, arachidyl alcohol, behenyl alcohol, tetracosanol, hexacosanol, octacosanol, and triacontanol.

Specific examples of the dibasic carboxylic acid include butanedioic acid (succinic acid), pentanedioic acid (glutaric acid), hexanedioic acid (adipic acid), heptanedioic acid (pimelic acid), octanedioic acid (suberic acid), nonanedioic acid (azelaic acid), decanedioic acid (sebacic acid), dodecanedioic acid, tridecanedioic acid, tetradecanedioic acid, hexadecanedioic acid, octadecanedioic acid, eicosanedioic acid, phthalic acid, isophthalic acid, and terephthalic acid.

Specific examples of the dihydric alcohol include ethylene glycol, propylene glycol, 1,3-propanediol, 1,4-butanediol, 1,5-pentanediol, 1,6-hexanediol, 1,10-decanediol, 1,12-dodecanediol, 1,14-tetradecanediol, 1,16-hexadecanediol, 1,18-octadecanediol, 1,20-eicosanediol, 1,30-triacontanediol, diethylene glycol, dipropylene glycol, 2,2,4-trimethyl-1,3-pentanediol, neopentyl glycol, 1,4-cyclohexanedimethanol, spiroglycol, 1,4-phenylene glycol, bisphenol A, and hydrogenated bisphenol A.

Examples of other waxes include paraffin waxes, microcrystalline waxes, and petrolatum, and derivatives thereof; montan wax and derivatives thereof; Fischer-Tropsch wax, and derivatives thereof; hydrocarbon waxes such as polyolefin waxes such as polyethylene and polypropylene, and derivatives thereof; natural waxes such as candelilla wax, and derivatives thereof; higher aliphatic alcohols; and fatty acids such as stearic acid and palmitic acid, and compounds thereof. The content of the wax is preferably 5.0 parts by mass or more and 20.0 parts by mass or less with respect to 100.0 mass parts of the binder resin.

[Colorant]

In the present invention, when a colorant is incorporated in the toner particle, the colorant is not particularly limited, and the following known colorants can be used.

Yellow iron oxide, Naples Yellow, Naphthol Yellow S, Hansa Yellow G, Hansa Yellow 10 G, Benzidine Yellow G, Benzidine Yellow GR, quinoline yellow lake, condensed azo compounds such as Permanent Yellow NCG and tartrazine lake, isoindolinone compounds, anthraquinone compounds, azo metal complexes, methine compounds, and allylamide compounds are used as yellow pigments. Specific examples thereof include the following.

C. I. Pigment Yellow 12, 13, 14, 15, 17, 62, 74, 83, 93, 94, 95, 109, 110, 111, 128, 129, 147, 155, 168, and 180.

Examples of the red pigments include Red iron oxide; condensed azo compounds such as Permanent Red 4R, Lithol Red, Pyrazolone Red, Watching Red calcium salt, Lake Red C, Lake Red D, Brilliant Carmine 6B, Brilliant Carmine 3B, eosin lake, Rhodamine Lake B, and Alizarin Lake; diketopyrrolopyrrole compounds; anthraquinone; quinacridone compounds; basic dye lake compounds; naphthol compounds; benzimidazolone compounds; thioindigo compounds; and perylene compounds. Specific examples thereof include the following.

C. I. Pigment Red 2, 3, 5, 6, 7, 23, 48:2, 48:3, 48:4, 57:1, 81:1, 122, 144, 146, 166, 169, 177, 184, 185, 202, 206, 220, 221, and 254.

Examples of the blue pigments include alkali blue lake; Victoria Blue Lake; copper phthalocyanine compounds and derivatives thereof, for example, Phthalocyanine Blue, metal-free Phthalocyanine Blue, partially chlorinated Phthalocyanine Blue, Fast Sky Blue, and Indathrene BG; anthraquinone compounds; and basic dye lake compounds. Specific examples thereof include the following.

C. I. Pigment Blue 1, 7, 15, 15:1, 15:2, 15:3, 15:4, 60, 62, and 66.

Examples of the black pigments include carbon black and aniline black. A single one or a mixture of these colorants can be used, and these colorants may also be used in the form of solid solutions.

The content of the colorant is preferably 3.0 to 15.0 parts by mass with respect to 100.0 parts by mass of the binder resin or polymerizable monomer.

[Charge Control Agent]

In the present invention, the toner base may contain a charge control agent. A known charge control agent may be used as the charge control agent. In certain embodiments, charge control agents that provide a fast charging speed and are able to stably maintain a certain charge quantity are utilized.

Examples of the charge control agent that controls the toner particle to negative charging include the following:

as organometal compounds and chelate compounds, monoazo metal compounds, acetylacetone-metal compounds, and metal compounds of aromatic oxycarboxylic acids, aromatic dicarboxylic acids, oxycarboxylic acids, and dicarboxylic acids. Others include aromatic oxycarboxylic acids, aromatic monocarboxylic acids, and aromatic polycarboxylic acids and their metal salts, anhydrides, and esters, as well as phenol derivatives such as bisphenol. Additional examples thereof include urea derivatives, metal-containing salicylic acid compounds, metal-containing naphthoic acid compounds, boron compounds, quaternary ammonium salts, and calixarene.

Examples of the charge control agent that controls the toner particle to positive charging, on the other hand, include the following: nigrosine and nigrosine modifications by, for example, fatty acid metal salts; guanidine compounds; imidazole compounds; quaternary ammonium salts such as tributylbenzylammonium 1-hydroxy-4-naphthosulfonate and tetrabutylammonium tetrafluoroborate, and their onium salt analogues, such as phosphonium salts, and their lake pigments; triphenylmethane dyes and their lake pigments (examples of the laking agent include phosphotungstic acid, phosphomolybdic acid, phosphomolybdotungstic acid, tannic acid, lauric acid, gallic acid, ferricyanides, and ferrocyanides); metal salts of higher fatty acids; and charge control resins.

These charge control agents may be incorporated singly or in combination of two or more thereof. The amount of these charge control agents to be added is preferably 0.01 to 10.00 parts by mass with respect to 100.00 parts by mass of the polymerizable monomer.

[External Additive]

The external additive may be a known external additive, and examples thereof include metal oxide fine particles (inorganic fine particles) such as silica fine particles, alumina fine particles, titania fine particles, zinc oxide fine particles, strontium titanate fine particles, cerium oxide fine particles, and calcium carbonate fine particles.

By changing the reaction conditions or the drying conditions, the amount of hydroxyl groups or water of hydration contained in these can be adjusted, and the heating loss by TGA can be adjusted. A sol-gel method is preferably used as the production method.

Other additives may also be used in the toner in small amounts within a range that substantially does not exercise a negative effect, for example, lubricant powders such as a fluororesin powder, zinc stearate powder, polyvinylidene fluoride powder, and so forth; abrasives such as cerium oxide powder, silicon carbide powder, strontium titante powder, and so forth; fluidity-imparting agents such as, for example, titanium oxide powder, aluminum oxide powder, and so forth; anticaking agents; and a reverse-polarity organic fine powder or inorganic fine powder as a development performance improving agent. These additives may also be used after carrying out a surface hydrophobic treatment thereon.

[Toner Particle Size]

The weight-average particle size (D4) of the toner is preferably 3.0 to 12.0 μm, more preferably 4.0 to 10.0 μm. When the weight-average particle size (D4) is in the above range, good fluidity is obtained, and latent images can be faithfully developed.

[Method for Producing Toner]

Conventionally known methods can be used without particular limitation as the method of producing the toner of the present invention. Specific examples thereof include suspension polymerization methods, solution suspension methods, emulsion aggregation methods, spray-drying methods, and pulverization methods. Among them, the pulverization method is preferable. In the pulverization method, the vicinity of the inorganic oxide particle is likely to be a pulverization interface in the pulverization step, and the inorganic oxide particles are likely to be present outside the wax domain, and thus the effects of the present invention can be easily obtained.

Specific examples of the pulverization method for producing a toner through the melt-kneading step and the pulverization step are shown below, but the present invention is not limited thereto.

For example, the binder resin, the wax, and the inorganic oxide particle, and as necessary, the colorant, the charge control agent, and other additives are sufficiently mixed using a mixer such as a Henschel mixer or a ball mill (mixing step). The obtained mixture is melt-kneaded using a heat kneader such as a twin-screw kneading extruder, a heating roll, a kneader, or an extruder (melt-kneading step).

After the obtained melt-kneaded product is cooled and solidified, the melt-kneaded product is pulverized using a pulverizer (pulverization step) and classified using a classifier (classification step) to obtain a toner particle. Subsequently, the toner particle and the external additive are mixed with a mixer such as a Henschel mixer (external addition step) to obtain a toner.

As external addition conditions, a higher rotational speed of the mixing blade and a longer mixing time are preferable because the external additive can be uniformly adhered to the surfaces of the toner base particles.

However, when the rotation speed of the mixing blade is too high or the mixing time is too long, frictional heat between the toner and the mixing blade becomes increases, and the toner may rise in temperature and fuse. Therefore, it is preferable to actively cool the mixer by providing a mixing blade or a water-cooling jacket to the mixer. It is preferable to adjust the rotation speed of the mixing blade and the mixing time so that the temperature in the mixer is 45° C. or lower. Specifically, the maximum circumferential speed of the mixing blade is preferably 10.0 to 150.0 m/sec, and the mixing time is preferably adjusted within the range of 0.5 to 60 minutes.

The external addition step may be performed in one stage or in two or more stages, and the mixing apparatus, the mixing conditions, the blending of the toner base particles, and the like used in each stage may be the same as or different from each other.

Examples of the mixer include the following: FM Mixer (manufactured by Mitsui Mining Co., Ltd.); Super Mixer (manufactured by KAWATA MFG. CO., LTD.); Ribocone (manufactured by OKAWARA MFG. CO., LTD.); Nauta Mixer, Turbulizer, and Cyclomix (manufactured by Hosokawa Micron Corporation); Spiral Pin Mixer (manufactured by Pacific Machinery & Engineering Co., Ltd.); and Lodige Mixer (manufactured by MAT SUBO Corporation).

Examples of the hot kneader include the following: KRC Kneader (manufactured by Kurimoto, Ltd.); Buss Co-Kneader (manufactured by Buss A G), TEM-type Extruder (manufactured by TOSHIBA MACHINE MACHINERY CO., LTD.); TEX Twin-Screw Kneader (manufactured by The Japan Steel Works, Ltd.); PCM Kneader (manufactured by Ikegai Corp); three-roll mill, mixing roll mill, and kneader (manufactured by INOUE MFG., INC.); Kneadex (manufactured by MITSUI MINING & SMELTING CO., LTD.); MS-type pressure kneader and Kneader-Ruder (manufactured by Moriyama Manufacturing Co., Ltd.); and Banbury mixer (manufactured by Kobe Steel, Ltd.).

Examples of the pulverizer include the following: Counter Jet Mill, Micron Jet, and Inomizer (Hosokawa Micron Corporation); IDS mill and PJM Jet Mill (Nippon Pneumatic Mfg. Co., Ltd.); Cross Jet Mill (Kurimoto, Ltd.); Ulmax (NISSO ENGINEERING CO., LTD.); SK Jet-O-Mill (Seishin Enterprise Co., Ltd.); Kryptron (Kawasaki Heavy Industries, Ltd.); Turbo Mill (Turbo Kogyo Co., Ltd.); and Super Rotor (NISSHIN ENGINEERING INC.).

Examples of the classifier include the following: Classiel, Micron Classifier, and Spedic Classifier (Seishin Enterprise Co., Ltd.); Turbo Classifier (NISSHIN ENGINEERING INC.); Micron Separator, Turboplex (ATP), and TSP Separator (Hosokawa Micron Corporation); Elbow Jet (Nittetsu Mining Co., Ltd.); Dispersion Separator (Nippon Pneumatic Mfg. Co., Ltd.); and YM Microcut (Yasukawa Shoji Co., Ltd.).

Examples of the sieving apparatus that can be used to screen out the coarse particles include the following: Ultrasonic (Koei Sangyo Co., Ltd.); Rezona Sieve and Gyro-Sifter (TOKUJU CORPORATION); Vibrasonic System (DALTON CORPORATION); Soniclean (SINTOKOGIO, LTD.); Turbo Screener (Turbo Kogyo Co., Ltd.); Microsifter (Makino Mfg. Co., Ltd.); and circular vibrating sieves.

[Measurement Method of Each Physical Property]

Next, methods for measuring each physical property will be described.

<Composition Analysis of Inorganic Oxide Particle>

The inorganic oxide particles contained in the toner particle of the present invention refer to the inorganic oxide particles contained in the toner particle at the time before the external addition step. Based on cross-sectional images of the toner particle observed by a transmission electron microscope (TEM), the inorganic oxide particles contained in the toner particle are taken as the particles having an area of 80% or more inside the outer circumference of the toner 100 nm or more. In addition, an energy dispersive X-ray spectrometer (EDX) is used to confirm that the particles includes at least one element selected from Si, Mg, Al, Ti, and Sr and oxygen, and to specify the composition of the inorganic oxide particles.

An image of a cross-section of a toner particle by a transmission electron microscope (TEM) is prepared as follows.

An Os film (5 nm) and a naphthalene film (20 nm) are applied as protective films to the toner by using an osmium plasma coater (Filgen, Inc., OPC80T), and the resultant is embedded in a photocurable resin D800 (JEOL Ltd.), and then, a toner particle cross-section having a thickness of 60 nm (or 70 nm) is produced with an ultrasonic ultramicrotome (Leica Microsystems GmbH, UC7) at a cutting speed of 1 mm/s.

The obtained cross-section is observed by STEM using the STEM function of a TEM (JEOL Ltd., JEM-2800). The STEM probe size is 1 nm, and the image size is 1024×1024 pixels. Among the cross-sections of the toner particle, a cross-section having a diameter of 0.9 times to 1.1 times the weight-average particle size is selected.

<Measurement of Major Axis a, Area Sm, and Shape Factor SF-1 of Inorganic Oxide Particles, Shortest Distance B Between Inorganic Oxide Particles and Toner Surface, and Shortest Distance C Between Wax Domain and Toner Surface>

With respect to the obtained image, the major axis of the inorganic oxide particles, the shortest distance between the inorganic oxide particles and the toner surface, and the shortest distance between the wax domain and the toner surface are respectively obtained using image processing software “Image-Pro Plus ver. 4.0 (manufactured by Media Cybernetics, Inc.)”. In the calculation of the major axis A and the shortest distances B and C, the cross-sections of 100 toner particles are observed, and the respective number average values are taken as the major axis A of the inorganic oxide particles, the shortest distance B between the inorganic oxide particles and the toner surface, and the shortest distance C between the wax domain and the toner surface. Similarly, the cross-sections of 100 toner particles are observed, the areas of the inorganic oxide particles are obtained, and the average value thereof is taken as the area Sm of the inorganic oxide particles.

In addition, the shape factor SF-1 of the inorganic oxide particles is obtained by the following formula from the major axis of the inorganic oxide particles and the area Sm of the inorganic oxide particles calculated above.

SF−1=(major axis of inorganic oxide particles)²/area of inorganic oxide particles Sm×π/4×100

SF−1 is calculated from cross-sectional observation of 100 toner particles, and the average value is taken as the shape factor SF1 of the inorganic oxide particles.

In a case where it is difficult to distinguish the wax domain, a clear image can be obtained by performing TEM observation with respect to the toner particle cross-section after further staining with ruthenium as described below. Specifically, using a vacuum electron dyeing apparatus (Filgen, Inc., VSC4R1H), dyeing is performed for 15 minutes in a RuO4 gas atmosphere of 500 Pa.

Ruthenium staining increases the contrast of the wax domain contained in the toner particle, which can thus be easily observed. When ruthenium staining is used, because the amount of ruthenium atoms varies depending on the intensity of the staining, the strongly stained area contains more of these atoms and is black on the observation image without electron beam transmission, and the weakly stained area is white on the observation image with electron beam transmission. The wax domain appears white because the penetration of ruthenium is more suppressed than other organic components forming the toner particle.

<Observation of Sharp Portion of Inorganic Oxide Particles>

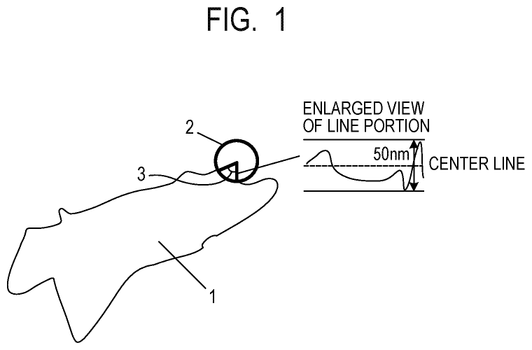

In the image in which the inorganic oxide particles are observed, the angle of the end portion is calculated using image processing software “Image-Pro Plus ver. 4.0 (manufactured by Media Cybernetics, Inc.)”. Specifically, as shown in FIG. 1, the end portion of the inorganic oxide particle (1 in the figure) is detected by the edge detector of the software.

A circle with a radius of 200 nm centered on the detected end portion (indicated by 2 in the figure) is drawn. Two straight lines connecting the intersection point of the circle and the outline of the inorganic oxide particle and the end portion are drawn, and lines having a width of 50 nm (in the figure, two lines extending from the center of the circle 2 to the outline of the circle 2) are drawn with the straight lines as the center.

The outline of the inorganic oxide particle included in the two lines having a width of 50 nm is shown in the “enlarged view of line portion” in the figure. Here, in a case where the outline of the inorganic oxide particle does not fall within the 50 nm, the end portion thereof is not analyzed. The angle (3 in the figure) formed by the two lines having a width of 50 nm is analyzed by the above software, and when the angle is 90° or less, it is determined that the inorganic oxide particles have a sharp portion.

The cross-sections of 100 toner particles are observed, and in a case where 90% or more of the inorganic oxide particles have a sharp portion, it is determined that the inorganic oxide particles contained in the toner particle have a sharp portion.

<Measurement of Major Axis D of External Additive>

The major axis D of the external additive is measured using a scanning electron microscope “S-4800” (trade name; manufactured by Hitachi, Ltd.). The toner to which the external additive has been externally added is observed, the major axes of 100 primary particles of the external additive are randomly measured in a field of view magnified 50,000 times, and the average value thereof is taken as the major axis D of the external additive. The observation magnification is appropriately adjusted according to the size of the external additive.

<Composition Analysis of Binder Resin>

Separation Method of Binder Resin

In 3 ml of chloroform, 100 mg of toner are dissolved. Then, the insoluble matter is then separated by suction filtration with a syringe fitted with a sample treatment filter (using, e.g., a pore size of 0.2 μm or more and 0.5 μm or less, for example, a Myshori Disc H-25-2 (Tosoh Corporation)). The soluble matter is introduced onto a preparative HPLC (apparatus: LC-9130 NEXT, Japan Analytical Industry Co., Ltd., [60 cm] preparative column, exclusion limits: 20,000, 70,000, 2-column train) and a chloroform elution solution is pumped through. Once peaks can be identified on the resulting chromatograph display, fractions of the retention time corresponding to a molecular weight of 2,000 or more as provided by a monodisperse polystyrene standard sample are collected. The solution of the obtained fraction is dried and solidified to obtain a binder resin.

Measurement of component identification and mass ratio of binder resin by nuclear magnetic resonance spectroscopy (NMR)

To 20 mg of the toner, 1 mL of deuterated chloroform is added and the NMR spectrum of protons of the dissolved binder resin is measured. The molar ratio and mass ratio of each monomer can be calculated from the obtained NMR spectrum, and the content of the constituent monomer units of the binder resin such as styrene-acrylic resin can be obtained. For example, in the case of a styrene acrylic copolymer, the composition ratio and mass ratio can be calculated based on a peak derived from the styrene monomer in the vicinity of 6.5 ppm and a peak derived from the acrylic monomer in the vicinity of 3.5 to 4.0 ppm. Further, in the case of a copolymer of a polyester resin and a styrene-acrylic resin, the molar ratio and the mass ratio are calculated together with the peak derived from each monomer constituting the polyester resin and the peak derived from the styrene acrylic copolymer, and the content of the monomer unit of the polyester resin is obtained.

NMR apparatus: JEOL RESONANCE ECX500

Observation nucleus: proton, measurement mode: single pulse, reference peak: TMS

<Measurement of Weight-Average Molecular Weight Mw, Number-Average Molecular Weight Mn, and Peak Molecular Weight>

The molecular weight distribution (weight-average molecular weight Mw, number-average molecular weight Mn, peak molecular weight) of crystalline materials and resins is measured by gel permeation chromatography (GPC) as follows.

First, the sample is dissolved in tetrahydrofuran (THF) at room temperature for 24 hours. Then, the obtained solution is filtered through a solvent-resistant membrane filter “Myshori Disc” (manufactured by Tosoh Corporation) having a pore diameter of 0.2 μm to obtain a sample solution. The sample solution is adjusted so that the concentration of the fraction soluble in THF is 0.8% by mass. This sample solution is used for measurement under the following conditions.

Apparatus: HLC8120 GPC (Detector: RI) (manufactured by Tosoh Corporation)

Column: seven sets of Shodex KF-801, 802, 803, 804, 805, 806, and 807 (manufactured by Showa Denko K.K.)

Eluent: tetrahydrofuran (THF)

Flow rate: 1.0 ml/min

Oven temperature: 40.0° C.

Sample injection volume: 0.10 ml

For calculating the molecular weight of the sample, a molecular weight calibration curve created using standard polystyrene resins (for example, trade name “TSK standard polystyrene F-850, F-450, F-288, F-128, F-80, F-40, F-20, F-10, F-4, F-2, F-1, A-5000, A-2500, A-1000, and A-500”, manufactured by Tosoh Corporation) is used.

<Measurement of Toner Particle Size>

A precision particle size distribution analyzer (trade name: Multisizer 3 Coulter Counter) by an aperture impedance method and dedicated software (trade name: Beckman Coulter Multisizer 3 Version 3.51, manufactured by Beckman Coulter, Inc.) are used. Measurement is performed at 25,000 effective measuring channels with an aperture diameter of 100 μm, and the resulting measurement data is analyzed, and the particle size is calculated. The electrolytic aqueous solution used for the measurements is prepared by dissolving special-grade sodium chloride in ion-exchanged water to provide a concentration of approximately 1% by mass and, for example, ISOTON II (trade name) from Beckman Coulter, Inc. can be used. The dedicated software is set up as described below prior to the measurement and analysis.

On the “Standard operation mode (SOM) setting screen” of the dedicated software, the total count number in control mode is set at 50,000 particles, the number of measurements is set at 1, and the Kd value is set at a value obtained with “standard particles 10.0 μm” (manufactured by Beckman Coulter, Inc). A threshold/noise level measurement button is pushed to automatically set the threshold and noise level. The current is set at 1600 μA, the gain is set at 2, Isoton II (trade name) is chosen as an electrolytic solution, and Flushing of an aperture tube after measurement is checked.

On the “Conversion of pulse into particle size setting screen” of the dedicated software, the bin interval is set at logarithmic particle size, the particle size bin is set at 256 particle size bins, and the particle size range is set at 2 μm or more and 60 μm or less.

The specific measurement method is described below.
(1) Into a special 250-mL round-bottom glass beaker for Multisizer 3, about 200 mL of the electrolytic aqueous solution is charged, the glass beaker is placed on a sample stand, and the electrolytic aqueous solution is stirred counterclockwise with a stirrer rod at 24 revolutions per second. Soiling and air bubbles in the aperture tube are removed using the “Aperture flushing” function of the analysis software.
(2) About 30 mL of the electrolytic aqueous solution is charged into a 100-mL flat-bottom glass beaker. About 0.3 mL of Contaminon N (trade name, 10% by mass aqueous solution of neutral detergent for cleaning precision measuring equipment, manufactured by Wako Pure Chemical Industries, Ltd.) diluted 3 times by mass with ion-exchanged water is added thereto.
(3) A predetermined amount of ion-exchanged water and about 2 mL Contaminon N (trade name) are charged into a water tank of an ultrasonic disperser (trade name: Ultrasonic Dispersion System Tetora 150, manufactured by Nikkaki-Bios Co., Ltd.) that has an electrical output of 120 W and that includes two built-in oscillators having an oscillation frequency of 50 kHz and a phase difference of 180°.
(4) The beaker provided in item (2) is placed in a beaker-holding hole in the ultrasonic disperser, and the ultrasonic disperser is operated. The height level of the beaker is adjusted in such a manner that the resonance state of the surface of the electrolytic aqueous solution in the beaker is maximal.
(5) About 10 mg of a toner (particles) is gradually added to the electrolytic aqueous solution and dispersed while the electrolytic aqueous solution in the beaker prepared in item (4) is irradiated with ultrasonic waves. The ultrasonic dispersion treatment is continued for another 60 seconds. The water temperature in the water tank is appropriately controlled to 10° C. or more and 40° C. or less during the ultrasonic dispersion.
(6) The electrolytic aqueous solution, containing the toner (particles) dispersed therein, in item (5) is added dropwise using a pipette to the round-bottom beaker placed on the sample stand in item (1) in such a manner that the measurement concentration is about 5%. Measurement is continued until the number of particles measured reaches 50,000.
(7) The measured data are analyzed using the dedicated software attached to the analyzer to determine the weight-average particle size (D4). The weight-average particle size (D4) is the “average size” on the analysis/volume statistics (arithmetic mean) screen in the setting of graph/% by volume in the dedicated software. The number-average particle size (D1) is the “Average size” on the “Analysis/number statistics (arithmetic mean)” screen in the setting of graph/% by number in the dedicated software.

<Method of Wettability Testing with Respect to Methanol/Water Mixed Solvent>

The wettability test of the toner with respect to the methanol/water mixed solvent is carried out by using a powder wettability tester “WET-100P” (manufactured by RHESCA Co., LTD.) under the following conditions and according to the following procedure, and calculations are performed from the obtained methanol drop transmittance curve.

A spindle-type rotor coated with a fluororesin and having a length of 25 mm and a maximum barrel diameter of 8 mm is placed in a cylindrical glass container having a diameter of 5 cm and a thickness of 1.75 mm.

A total of 60 ml of reverse osmosis membrane-treated water (RO water) is charged in the cylindrical glass container and treated for 5 min with an ultrasonic disperser in order to remove air bubbles and the like.

A total of 0.1 g of the toner is accurately weighed and added thereto to prepare a measurement sample liquid.

Methanol is continuously added at a dropping rate of 0.8 ml/min to the sample liquid for measurement through the powder wettability tester while stirring the spindle-type rotor in the cylindrical glass container at a speed of 300 rpm by using a magnetic stirrer.

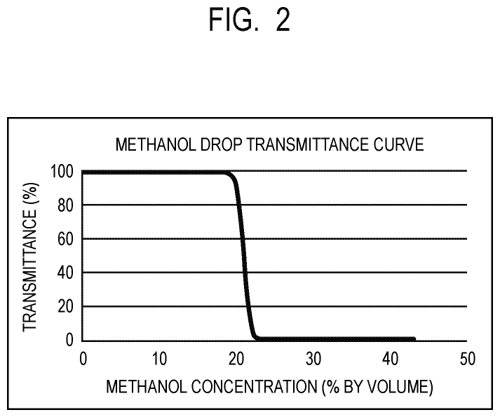

The transmittance is measured with light having a wavelength of 780 nm, and a methanol drop transmittance curve as illustrated in FIG. 2 is plotted. From the obtained methanol drop transmittance curve, a methanol concentration (TA) when the transmittance shows 50% is read.

The methanol concentration (TA; % by volume) is a value calculated from [(the volume of methanol present in the cylindrical glass container)/(the volume of the mixture of methanol and water present in the cylindrical glass container)×100].

<Heating Loss of External Additive>

Measurement is performed using a thermal analyzer TGA7 manufactured by PerkinElmer, Inc. The external additive is heated from room temperature to 500° C. at a temperature-increasing rate of 25° C./min in a nitrogen atmosphere, and the weight loss in % by mass between 200° C. and 400° C. is taken as the heating loss of the external additive.

When the external additive to be used for external addition is available, the measurement may be performed using the external additive. When the external additive separated from the surface of the toner particle is used as the measurement sample, the external additive is separated from the toner particle by the following procedure.

1) In the Case of Non-Magnetic Toner

To 100 mL of ion-exchanged water, 160 g of sucrose (manufactured by KISHIDA CHEMICAL Co., Ltd.) is added and dissolved using a hot water bath to prepare a sucrose syrup. Into a centrifuge tube, 31 g of the sucrose syrup and 6 mL of Contaminon N are charged to prepare a dispersion. To this dispersion, 1 g of toner is added, and clumps of the toner are broken up with a spatula or the like.

The centrifuge tube is reciprocally shaken for 20 minutes under conditions of 350 reciprocations per minute on the shaker mentioned above. The dispersion thus shaken is transferred to a glass tube for a swing rotor (50 mL), and centrifuged for 30 minutes at 58.33 S⁻¹ with a centrifuge (H-9R; Kokusan Co., Ltd.). In the glass tube thus centrifuged, toner is present in the uppermost layer while the external additive is present on the aqueous solution side serving as the bottom layer. The aqueous solution serving as the bottom layer is collected and centrifuged to separate the external additive from the sucrose and thereby collect the external additive. As necessary, centrifugation is repeatedly performed for thorough separation, followed by drying of the dispersion and collection of the external additive.

When a plurality of external additives are used, a desired external additive may be selected from the collected external additives by utilizing centrifugal separation or the like.

2) In the Case of Magnetic Toner

First, 6 mL of Contaminon N (aqueous solution containing 10% by mass of a neutral detergent for cleaning precision measuring equipment, which has a pH of 7 and contains a nonionic surfactant, an anionic surfactant and an organic builder; manufactured by Wako Pure Chemical Industries, Ltd.) is added to 100 mL of ion-exchanged water to prepare a dispersion medium. To this dispersion medium, 5 g of toner is added and dispersed for 5 minutes in an ultrasonic disperser (VS-150, manufactured by AS ONE CORPORATION). Thereafter, the dispersion is loaded in a “KM Shaker” (model: V. SX) manufactured by Iwaki Industry Co., Ltd., and reciprocally shaken for 20 minutes at 350 reciprocations per minute.

Thereafter, the toner particle is then constrained using a neodymium magnet, and the supernatant liquid is collected. The external additive is collected by drying this supernatant liquid. In cases where a sufficient amount of the external additive cannot be collected, this operation is repeated.

As in the case of the non-magnetic toner, when a plurality of external additives are used, desired external additives are selected from the collected external additives using centrifugal separation or the like.

### Examples

The present invention will be described in more detail below by way of Production Examples and Examples, but these are not intended to limit the present invention in any way. All parts in the following formulations are parts by mass.

<Production Example of Inorganic Oxide Particle 1>

Ilmenite ore was dried, ground and treated with concentrated sulfuric acid for digestion/extraction. After removing the unreacted ore, the iron sulfate was decrystallized. An aqueous solution of sodium hydroxide was added to the obtained titanyl sulfate to adjust the pH to 9.0, and desulfurization was performed, after which the pH was neutralized to 5.8 with hydrochloric acid, and the product was filtered and washed. After firing in a heating furnace, the pulverization was performed while adjusting the screen size, the rotation speed, and the number of passes of the pulverizer to obtain titanium oxide as inorganic oxide particle 1. Table 1 shows the physical properties of the inorganic oxide particle 1.

<Production Example of Inorganic Oxide Particle 2>

A magnesium oxide powder (Pyrokisuma 3320, Kyowa Chemical Industry Co., Ltd.) was pulverized using a pulverizer while adjusting the screen size, the rotation speed, and the number of passes to obtain magnesium oxide particles as inorganic oxide particle 2. Table 1 shows the physical properties of the inorganic oxide particle 2.

### Production Example of Inorganic Oxide Particle 3

Ilmenite ore was dried, ground and treated with concentrated sulfuric acid for digestion/extraction. After removing the unreacted ore, the iron sulfate was decrystallized. An aqueous solution of sodium hydroxide was added to the obtained titanyl sulfate to adjust the pH to 9.0, and desulfurization was performed, after which the pH was neutralized to 5.8 with hydrochloric acid, and the product was filtered and washed. Water was added to the washed cake to form a slurry containing 1.5 mol/L of TiO₂, and hydrochloric acid was added to adjust the pH to 1.5 for peptization. The desulfurized and peptidized metatitanic acid was collected as TiO₂, and placed in a 3 L reaction vessel. A strontium chloride aqueous solution was added to the peptidized metatitanic acid slurry to obtain an SrO/TiO₂ molar ratio of 1.18, after which the TiO₂ concentration was adjusted to 0.9 mol/L.

Next, the mixture was heated to 90° C. under stirring and mixing, and nitrogen gas microbubbling was performed at 600 ml/min as 444 mL of a 10 mol/L sodium hydroxide aqueous solution was added over 50 minutes, and thereafter nitrogen gas microbubbling was performed at 400 ml/min as the mixture was stirred for 1 hour at 95° C. Thereafter, the reaction slurry was stirred and rapidly cooled to 12° C. while cooling water at 10° C. water was passed through the jacket of the reaction vessel, neutralized by adding hydrochloric acid, stirred for 1 hour, and then filtered and separated. After firing in a heating furnace, the pulverization was performed while adjusting the screen size, the rotation speed, and the number of passes of the pulverizer to obtain strontium titanate as inorganic oxide particle 3. Table 1 shows the physical properties of the inorganic oxide particle 3.

### Production Example of Inorganic Oxide Particle 4

Using bauxite as a raw material, aluminum oxide was refined by the Bayer method. Sodium hydroxide was added to the bauxite and dissolved by heating at 250° C. Insoluble matter was removed by filtration, and the residue was cooled to recover aluminum hydroxide as a solid. The aluminum hydroxide was heated and dehydrated at 1050° C. to obtain aluminum oxide. Subsequently, the pulverization was performed while adjusting the screen size, the rotation speed, and the number of passes of the pulverizer to obtain aluminum oxide particles as inorganic oxide particle 4. Table 1 shows the physical properties of the inorganic oxide particle 4.

### Production Example of Inorganic Oxide Particle 5

A mixed gas containing argon and oxygen at a volume ratio of 3:1 was introduced into the reaction vessel to substitute the atmosphere.

The reaction vessel was supplied with oxygen gas at 40 (m³/hr) and hydrogen gas at 20 (m³/h), and an oxygen-hydrogen combustion flame was formed with an ignition apparatus. Then, a raw material metallic silicon powder was then introduced into the combustion flame using a hydrogen carrier gas having a pressure of 147 kPa (1.5 kg/cm²), thereby forming a dust cloud. The dust cloud was ignited by the combustion flame and caused an oxidation reaction due to the dust explosion. After the oxidation reaction, the inside of the reaction vessel was cooled to obtain silica powder having a number-average particle size of 6.50 μm. The silica powder was pulverized with a pulverizer (manufactured by Hosokawa Micron Corporation) to obtain silica of inorganic oxide particle 5 having a number-average particle size of 2.83 μm. Table 1 shows the physical properties of the inorganic oxide particle 5.

### Production Example of Inorganic Oxide Particles 6 to 10

In the production example of the silica particles 1, the pulverization was performed while adjusting the screen size, the rotation speed, and the number of passes of the pulverizer to obtain inorganic oxide particles 6 to 10 of silica. Table 1 shows the physical properties of the inorganic oxide particles 6 to 10.

TABLE 1

| Inorganic | | |
|---|---|---|
| oxide particle | Component | Particle size (μm) |
| 1 | TiO2 | 0.12 |
| 2 | MgO | 3.60 |
| 3 | SrTiO3 | 0.12 |
| 4 | Al2O3 | 3.60 |
| 5 | SiO2 | 3.60 |
| 6 | SiO2 | 1.26 |
| 7 | SiO2 | 0.62 |
| 8 | SiO2 | 2.41 |
| 9 | SiO2 | 0.06 |
| 10 | SiO2 | 4.90 |

### Production Example of External Additive 1

A reaction vessel equipped with a thermometer and a stirrer was charged with 360.0 parts of water, and 15.0 parts of hydrochloric acid having a concentration of 5.0% by mass was added to obtain a homogeneous solution. While this solution was stirred at a temperature of 25° C., 208.0 parts of tetraethoxysilane was added thereto, and the mixture was stirred for 5 hours to obtain a solution 1.

Next, another reaction vessel equipped with a thermometer, a stirrer, and a dropping apparatus was charged with 440.0 parts of water, and 17.0 parts of ammonia water having a concentration of 10.0% by mass was added to obtain a homogeneous solution. While this solution was stirred at a temperature of 30° C. (reaction temperature), 100 parts of the above solution 1 was added dropwise over 0.4 hours, and the mixture was stirred for 6 hours (reaction time) to obtain a suspension. The obtained suspension was subjected to a centrifugal separator to precipitate and take out fine particles, and the fine particles were dried in a dryer at a temperature of 150° C. for 24 hours, and then the TGA heating loss was adjusted to a desired TGA heating loss by adjusting the TGA heating loss adjustment temperature and time in the dryer to obtain an external additive 1. Table 2 shows the physical properties of the external additive 1.

### Production Examples of External Additives 2 to 7

External Additives 2 to 7 were obtained in the same manner except that the production conditions for the external additive 1 were changed to those shown in Table 2. Table 2 shows the physical properties of the external additives 2 to 7.

### Production Example of External Additive 8

Into a polytetrafluoroethylene inner cylindrical stainless steel autoclave, 500 parts of the external additive 5 was charged. After substituting the inside of the autoclave with nitrogen gas, 0.5 parts of hexamethyldisilazane (HMDS) and 0.1 parts of water were atomized by a two fluid nozzle and uniformly sprayed onto the powder of the external additive 5 while rotating a stirring blade attached to the autoclave at a 400 rpm.

After stirring for 30 minutes, the autoclave was closed and heated to 200° C. for 2 hours. Subsequently, the pressure in the system was reduced while heating to remove ammonia, thereby obtaining an external additive 8. Table 2 shows the physical properties of the external additive 8.

TABLE 2

| | | | TGA | TGA | | |
|---|---|---|---|---|---|---|
| | | | Heating loss | Heating loss | | TGA |
| | Reaction | Reaction | adjustment | adjustment | Particle | Heating |
| External | temperature | time | temperature | time | size | loss |
| additive | (° C.) | (time) | (° C.) | (time) | (nm) | (%) |
| 1 | 30 | 2 | None | | 150 | 8.0 |
| 2 | 35 | 1.5 | None | | 100 | 9.0 |
| 3 | 30 | 5 | 200 | 2 | 150 | 0.3 |
| 4 | 35 | 5 | 200 | 2 | 100 | 0.3 |
| 5 | 35 | 5 | None | | 100 | 4.0 |
| 6 | 35 | 2 | None | | 100 | 8.0 |
| 7 | 35 | 5 | 200 | 1 | 100 | 0.5 |

| | | | |
|---|---|---|---|
| 8 | Described in the description | 100 | 0.1 |

### Production Example of Toner 1

Binder resin A: 80.0 parts
   (styrene-acrylic resin having a mass ratio of styrene and n-butyl acrylate of 78:22; Mw=180000, Tg=58° C.)
Binder resin B: 20.0 parts
   (styrene-acrylic resin having a mass ratio of styrene and n-butyl acrylate of 90:10; Mw=5300, Tg=58° C.)
Hydrocarbon wax (paraffin wax HNP-9, NIPPON SEIRO CO., LTD.): 5.0 parts
Inorganic oxide particle 1: 2.0 parts
3,5-di-t-butylsalicylic acid aluminum compound: 0.5 parts
Carbon black: 5.0 parts

These materials were mixed at a rotation speed of 20 s⁻¹ for a rotation time of 5 minutes with a Henschel mixer (FM-75, manufactured by Mitsui Mining Co., Ltd.), and then kneaded in a twin-screw kneader (PCM-30, manufactured by Ikegai Corp) set at a temperature of 130° C. (the number of kneading operations; twice). The kneaded product was cooled to 25° C. and coarsely crushed to 1 mm or less in a hammer mill to obtain a crushed product. The coarsely crushed product obtained was finely pulverized with a mechanical pulverizer (T-250, manufactured by Turbo Kogyo Co., Ltd). Classification was performed using a multi-grade classifier utilizing the Coanda effect to obtain toner precursor particles having a weight-average particle size (D4) of 8.5 μm.

Next, through classification with an air classifier utilizing the Coanda effect (“ELBOW-JET LABO EJ-L3”, manufactured by Nittetsu Mining Co., Ltd.), fine powder and coarse powder were simultaneously classified and removed from the toner precursor particles, thereby obtaining a toner particle 1.

Next, 100.0 parts of the toner particle 1 and 1.5 parts of the external additive 1 were put into a Henschel mixer (FM-75, manufactured by Mitsui Miike Chemical Engineering Machinery, Co., Ltd.), and at a temperature of 30° C., the circumferential speed of the rotary blade set to 35 m/s and the mixing time was set to 8 minutes, and the mixture was passed through a sieve having an opening of 45 μm to obtain a toner 1. The production conditions and physical properties of the toner 1 are shown in Tables 3 and 4, respectively.

### Production Examples of Toners 2 to 14

Toners 2 to 14 were obtained in the same manner as in the production example of the toner 1 except that the production conditions were changed to those shown in Table 3. The production conditions and physical properties of the toners 2 to 14 are shown in Tables 3 and 4, respectively.

### Production Examples of Comparative Toners 1 to 4

Comparative toners 1 to 4 were obtained in the same manner as in the production example of the toner 1 except that the production conditions were changed to those shown in Table 3. The production conditions and physical properties of the comparative toners 1 to 4 are shown in Tables 3 and 4, respectively.

TABLE 3

| | | | | | | | Inorganic oxide | | Number of | External | |
|---|---|---|---|---|---|---|---|---|---|---|---|
| | Binder resin | | | | Wax | | particle | | kneading | additive | |
| Toner | Type | Parts | Type | Parts | Type | Parts | Type | Parts | operations | Type | Parts |
| Toner 1 | A | 80 | B | 20 | Behenyl | 5 | 1 | 1.5 | 2 | 1 | 2.0 |
| | | | | | behenate | | | | | | |
| Toner 2 | A | 80 | B | 20 | HNP-9 | 5 | 2 | 2.5 | 1 | 2 | 2.0 |
| Toner 3 | A | 80 | B | 20 | Behenyl | 5 | 3 | 1.5 | 2 | 3 | 2.0 |
| | | | | | behenate | | | | | | |
| Toner 4 | A | 80 | B | 20 | HNP-9 | 5 | 4 | 2.5 | 1 | 4 | 2.0 |
| Toner 5 | A | 80 | B | 20 | Behenyl | 5 | 5 | 2.5 | 2 | 4 | 2.0 |
| | | | | | behenate | | | | | | |
| Toner 6 | A | 80 | B | 20 | HNP-9 | 5 | 5 | 2.5 | 1 | 4 | 2.0 |
| Toner 7 | A | 80 | B | 20 | HNP-9 | 5 | 5 | 2.5 | 1 | 4 | 2.0 |
| Toner 8 | A | 80 | B | 20 | HNP-9 | 5 | 5 | 2.5 | 1 | 4 | 2.0 |
| Toner 9 | A | 80 | B | 20 | Behenyl | 5 | 6 | 2.0 | 2 | 5 | 2.0 |
| | | | | | behenate | | | | | | |
| Toner 10 | A | 80 | B | 20 | Behenyl | 5 | 7 | 2.0 | 1 | 6 | 1.5 |
| | | | | | behenate | | | | | | |
| Toner 11 | A | 80 | B | 20 | HNP-9 | 5 | 6 | 2.0 | 2 | 5 | 2.0 |
| Toner 12 | A | 80 | B | 20 | HNP-9 | 5 | 8 | 2.0 | 2 | 7 | 2.5 |
| Toner 13 | A | 100 | — | — | Behenyl | 5 | 6 | 2.0 | 2 | 5 | 2.0 |
| | | | | | behenate | | | | | | |
| Toner 14 | C | 100 | — | — | Behenyl | 5 | 6 | 2.0 | 2 | 5 | 2.0 |
| | | | | | behenate | | | | | | |
| Comparative | D | 100 | — | — | HNP-9 | 5 | 9 | 2.5 | 1 | 2 | 2.0 |
| toner 1 | | | | | | | | | | | |
| Comparative | D | 100 | — | — | Behenyl | 5 | 10 | 1.5 | 2 | 8 | 2.0 |
| toner 2 | | | | | behenate | | | | | | |
| Comparative | A | 100 | — | — | HNP-9 | 5 | 9 | 2.5 | 1 | 2 | 2.0 |
| toner 3 | | | | | | | | | | | |
| Comparative | A | 100 | — | — | Behenyl | 5 | 10 | 1.5 | 2 | 8 | 2.0 |
| toner 4 | | | | | behenate | | | | | | |

* Binder resin C: polyester resin in which a molar ratio of bisphenol A-ethylene oxide 2 mol adduct/bisphenol A-propylene oxide 2 mol adduct/terephthalic acid/dodecenylsuccinic acid is 48/48/70/25; Mw = 55000, Tg = 58° C.
* Binder resin D: styrene-acrylic resin having a mass ratio of styrene and n-butyl acrylate of 78:22; styrene-acrylic resin having Mw of 55000 and Tg of 58° C.

TABLE 4

| | Particle | | | | | | | | |
|---|---|---|---|---|---|---|---|---|---|
| | size of | Methanol | | | | | | | |
| | toner | concentration | | | | | | | |
| | particle | M | Major | Distance | Distance | Major | | | Heating |
| | D4 | (% by | axis A | B | C | axis D | | Sharp | loss |
| Toner | (μm) | volume) | (μm) | (μm) | (μm) | (μm) | SF-1 | portion | (%) |
| Toner 1 | 9.0 | 5.0 | 0.10 | 2.00 | 1.60 | 0.15 | 120 | No | 8.0 |
| Toner 2 | 8.8 | 5.0 | 3.00 | 0.40 | 0.35 | 0.10 | 120 | No | 9.0 |
| Toner 3 | 9.0 | 30.0 | 0.12 | 1.90 | 1.58 | 0.15 | 120 | No | 0.3 |
| Toner 4 | 8.6 | 30.0 | 2.98 | 0.42 | 0.35 | 0.10 | 120 | No | 0.3 |
| Toner 5 | 9.0 | 30.0 | 2.97 | 0.38 | 1.80 | 0.10 | 120 | No | 0.3 |
| Toner 6 | 8.9 | 30.0 | 3.00 | 0.44 | 0.35 | 0.10 | 120 | No | 0.3 |
| Toner 7 | 9.0 | 30.0 | 2.91 | 0.42 | 0.36 | 0.10 | 140 | No | 0.3 |
| Toner 8 | 9.0 | 30.0 | 2.88 | 0.42 | 0.32 | 0.10 | 140 | Yes | 0.3 |
| Toner 9 | 8.5 | 20.0 | 1.11 | 1.20 | 1.70 | 0.10 | 180 | Yes | 4.0 |
| Toner 10 | 8.0 | 15.0 | 0.48 | 1.50 | 1.12 | 0.10 | 140 | Yes | 8.0 |
| Toner 11 | 8.5 | 20.0 | 2.01 | 0.61 | 0.86 | 0.10 | 180 | Yes | 4.0 |
| Toner 12 | 7.5 | 25.0 | 2.11 | 0.50 | 0.88 | 0.10 | 120 | No | 0.5 |
| Toner 13 | 8.2 | 10.0 | 0.89 | 1.22 | 1.70 | 0.10 | 180 | Yes | 4.0 |
| Toner 14 | 8.2 | 20.0 | 0.95 | 1.18 | 1.77 | 0.10 | 180 | Yes | 4.0 |
| Comparative | 8.5 | 2.0 | 3.98 | 0.40 | 0.35 | 0.10 | 120 | No | 9.0 |
| toner 1 | | | | | | | | | |
| Comparative | 8.5 | 40.0 | 0.05 | 2.21 | 1.66 | 0.10 | 120 | No | 0.1 |
| toner 2 | | | | | | | | | |
| Comparative | 8.5 | 3.0 | 3.98 | 0.44 | 0.32 | 0.10 | 120 | No | 9.0 |
| toner 3 | | | | | | | | | |
| Comparative | 8.5 | 42.0 | 0.05 | 2.18 | 1.68 | 0.10 | 120 | No | 0.1 |
| toner 4 | | | | | | | | | |

### Examples 1 to 14, Comparative Examples 1 to 4

For the toners 1 to 14 and comparative toners 1 to 4, toner evaluation was performed using a modified version of a commercially available laser beam printer “LBP7600C” manufactured by Canon Inc. The modification was made by changing the gears and software of the main body of the evaluation apparatus so that the rotation speed of the developing roller was set so as to rotate at a circumferential speed 1.2 times as high as that of the drum. The following low-temperature fixability evaluation and durability evaluation were performed. Table 5 shows the evaluation results.

[Low-Temperature Fixability Evaluation]

A solid image (amount of toner applied: 0.9 mg/cm²) on a transfer material was evaluated by changing the fixing temperature. The fixing temperature is a value obtained by measuring the surface of the fixing roller using a non-contact thermometer. Letter size plain paper (XEROX 4200, manufactured by XEROX Corporation, 75 g/m²) was used as the transfer material. In the present invention, C or higher is an acceptable level.

(Evaluation Criteria)
A: No offset at 115° C.
B: Offset generated at 115° C.
C: Offset generated at 120° C.
D: Offset generated at 125° C.
E: Offset generated at 130° C.

[Durability Evaluation]

The following printout tests were performed under high-temperature and high-humidity (temperature: 33° C., humidity: 85% RH): a horizontal line image having a print percentage of 1% was printed out on 5,000 sheets and 10,000 sheets of paper, and after the completion of the tests, a solid image (amount of toner applied: 0.6 mg/cm²) was printed out on letter size plain paper (XEROX 4200 Paper, manufactured by XEROX Corporation, 75 g/m²), and white streaks were evaluated. At the same timing, a halftone (amount of toner applied: 0.2 mg/cm²) image was printed out, and dark streaks were evaluated. In the solid image and the halftone image, the reflectance (%) of the non-image portion was measured by “REFLECTOMETER MODEL TC-6DS” (manufactured by Tokyo Denshoku co., Ltd.). Fogging was evaluated using a numerical value (%) obtained by subtracting the obtained reflectance from the reflectance (%) of an unused printout paper (standard paper) measured in the same manner. The smaller the numerical value, the more the image fogging is suppressed.

(Solid Image Evaluation Criteria)
A: No white streaks
B: One or more and two or less white streaks
C: Three or more and four or less white streaks
D: Five or more and six or less white streaks
E: Seven or more white streaks
C or higher is an acceptable level.

(Halftone Image Evaluation Criteria)
A: No dark streaks
B: One or more and three or less dark streaks
C: Four or more and six or less dark streaks
D: Seven or more and nine or less dark streaks
E: Ten or more dark streaks, or presence of dark streak having a width of 0.5 mm or more.
C or higher is an acceptable level.

(Fogging Evaluation Criteria)
A: less than 0.5%
B: 0.5% or more and less than 1.5%
C: 1.5% or more and less than 3.0%
D: 3.0% or more and less than 4.5%
E: 4.5% or more
C or higher is an acceptable level.

TABLE 5

| | | | Solid image | | Halftone image | | Fogging | |
|---|---|---|---|---|---|---|---|---|
| | | Low- | evaluation | | evaluation | | evaluation | |
| | | fixability | 5,000 | 10,000 | 5,000 | 10,000 | 5,000 | 10,000 |
| | Toner | temperature | sheets | sheets | sheets | sheets | sheets | sheets |
| Example 1 | Toner 1 | C | B(1) | C(3) | B(1) | C(4) | B(0.5) | C(2.2) |
| Example 2 | Toner 2 | B | B(1) | C(3) | B(2) | C(5) | B(0.6) | C(2.2) |
| Example 3 | Toner 3 | C | B(1) | C(3) | B(1) | C(4) | B(0.5) | C(2.4) |
| Example 4 | Toner 4 | B | B(1) | C(3) | B(1) | C(4) | B(0.8) | C(2.2) |
| Example 5 | Toner 5 | B | A | B(1) | A | B(2) | A(0.2) | B(1.3) |
| Example 6 | Toner 6 | B | A | B(1) | A | B(2) | A(0.2) | B(1.2) |
| Example 7 | Toner 7 | B | B(1) | C(3) | B(1) | C(5) | B(0.5) | C(2.2) |
| Example 8 | Toner 8 | A | B(1) | C(3) | B(2) | C(5) | B(0.7) | C(2.3) |
| Example 9 | Toner 9 | A | A | A | A | A | A(0.2) | A(0.4) |
| Example 10 | Toner 10 | A | A | A | A | A | A(0.2) | A(0.4) |
| Example 11 | Toner 11 | A | A | A | A | A | A(0.3) | A(0.4) |
| Example 12 | Toner 12 | B | A | A | A | A | A(0.3) | A(0.4) |
| Example 13 | Toner 13 | C | A | A | A | A | A(0.2) | A(0.4) |
| Example 14 | Toner 14 | A | A | C(3) | A | C(4) | A(0.2) | C(2.2) |
| Comparative | Comparative | C | C(3) | C(4) | E(11) | E(7 mm) | E(4.8) | E(12.6) |
| Example 1 | toner 1 | | | | | | | |
| Comparative | Comparative | D | E(8) | E(13) | C(4) | C(6) | C(1.5) | C(2.8) |
| Example 2 | toner 2 | | | | | | | |
| Comparative | Comparative | D | B(2) | C(4) | D(9) | E(5 mm) | D(4.0) | E(8.2) |
| Example 3 | toner 3 | | | | | | | |
| Comparative | Comparative | E | D(6) | E(9) | B(3) | C(6) | B(1.3) | C(2.7) |
| Example 4 | toner 4 | | | | | | | |

According to the present disclosure, a toner excellent in low-temperature fixability and excellent in durability under harsh environments of high-temperature and high-humidity, and a method for producing the toner are provided.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2022-028818 filed Feb. 28, 2022, which is hereby incorporated by reference herein in its entirety.

What is claimed is:

1. A toner comprising:
a toner particle containing a binder resin, wax, and an inorganic oxide particle; and
an external additive,
wherein the inorganic oxide particle contains, as a main component, an oxide of at least one element selected from the group consisting of Si, Mg, Al, Ti, and Sr;
wherein,
when a thin piece obtained by cutting the toner with a microtome is observed with a transmission electron microscope (TEM), a major axis A of the inorganic oxide particle is 0.10 to 3.00 μm; and
in a wettability test of the toner with respect to a methanol/water mixed solvent, a methanol concentration at a transmittance of light having a wavelength of 780 nm of 50% is 5.0 to 30.0% by volume.

2. The toner according to claim 1, comprising at least one wax selected from the group consisting of an ester wax and a hydrocarbon wax.

3. The toner according to claim 1, wherein when the thin piece is observed with a transmission electron microscope (TEM), a relationship between a shortest distance B between the inorganic oxide particle and a surface of the toner particle and a shortest distance C between a domain of the wax and the surface of the toner particle satisfies B<C.

4. The toner according to claim 1, wherein when the thin piece is observed with a transmission electron microscope (TEM), a relationship between a shortest distance B between the inorganic oxide particle and a surface of the toner particle and the major axis A of the inorganic oxide particle satisfies A>B.

5. The toner according to claim 1, wherein a relationship between a major axis D of the external additive and the major axis A of the inorganic oxide particle satisfies A>D.

6. The toner according to claim 1, wherein when the thin piece is observed with a transmission electron microscope (TEM), the inorganic oxide particle have a shape factor SF-1 of 140 or more.

7. The toner according to claim 1, wherein when the thin piece is observed with a transmission electron microscope (TEM), the inorganic oxide particle have a sharp portion.

8. The toner of claim 1, wherein the inorganic oxide particle are silica particles.

9. The toner according to claim 1, wherein the external additive has a heating loss between 200° C. and 400° C. as measured by thermogravimetry (TGA) of 0.5 to 8.0%.

10. The toner according to claim 1, wherein the binder resin is a styrene-acrylic resin.

11. The toner according to claim 1, wherein, in a molecular weight distribution of a tetrahydrofuran-soluble matter of the binder resin, two or more peaks or shoulders are present between a weight-average molecular weight Mw of 3,000 and a weight-average molecular weight Mw of 2,000,000.

12. A method for producing a toner, the toner comprising a toner particle containing a binder resin, wax, and an inorganic oxide particle, and an external additive, the method comprising:
melt-kneading,
wherein the inorganic oxide particle contains, as a main component, an oxide of at least one element selected from the group consisting of Si, Mg, Al, Ti, and Sr;
when a thin piece obtained by cutting the toner with a microtome is observed with a transmission electron microscope (TEM), a major axis A of the inorganic oxide particle is 0.10 to 3.00 μm; and
in a wettability test of the toner with respect to a methanol/water mixed solvent, a methanol concentration at a transmittance of light having a wavelength of 780 nm of 50% is 5.0 to 30.0% by volume.
